(19) United States
(12) Patent Application Publication
(10) Pub. No.: US 2003/0081334 A1
(43) Pub. Date: May 1, 2003

(54) Combination side-view mirror with convex portion

(76) Inventor: Donald W. Skinner, Ed.D., Binghamton, NY (US)

Correspondence Address: BROWN & MICHAELS, PC, 400 M & T BANK BUILDING, 118 NORTH TIOGA ST, ITHACA, NY, 14850, US

(21) Appl. No.: 10/054,521

(22) Filed: Oct. 25, 2001

(51) Int. Cl. G02B 5/10; G02B 7/182

(52) U.S. Cl. 359/864; 359/871

(57) ABSTRACT

A side-view mirror having a unitary body with a convex portion, which makes up one third of the total amount of mirror, that allows the driver of the vehicle to see other vehicles in the blind spot of the vehicle. The remaining two thirds of the of mirror is a flat mirror, which allows the driver to see rear images.

### BACKGROUND OF THE INVENTION

1. Field of the Invention

The invention pertains to the field of mirrors for vehicles. More particularly, the invention pertains to a side-view mirror having multiple portions.

2. Description of Related Art

Side-view mirrors were originally attached to cars so that a driver could safely determine whether there were any obstacles to changing lanes. The problem associated with these mirrors is that there is a “blind spot” where a driver cannot see a car near a rear corner of his own car when the side-view mirror is aimed to show the road behind the driver's car. This blind spot is due to the traditional side-view mirror being flat. Most cars manufactured since 1982 are made with right-hand side-view mirrors which are entirely convex (usually in two dimensions—i.e. convex both up-and-down and also side-to-side), and thus help eliminate the right-hand blind spot at the expense of visibility down the road.

Other prior art includes stick-on round or rectangular “spot” mirrors which can be glued to a side-view mirror to add a small convex area. These are usually quite small, and being glued to an outside surface which is subject to weather extremes, has problems of longevity. These mirrors, as well, are usually two-dimensionally convex.

### SUMMARY OF THE INVENTION

The present invention eliminates the blind spot associated with the side-view mirrors by adding a convex portion of mirror to allow the driver to safely see both the rear images and the blind spot of the vehicle. The side-view mirror of the invention has a convex and flat mirror portion. The convex mirror is one third of the total amount of mirror present, and is preferably convex only from side-to-side while remaining undistorted along the vertical axis. The remaining two thirds of the mirror present is a flat mirror.

### BRIEF DESCRIPTION OF THE DRAWING

FIGS. 1 and 2 show a view of the mirror, with the convex portion beside the flat portion.

FIGS. 3 and 4 show a view of the mirror, with the convex portion above or below the flat portion.

### DETAILED DESCRIPTION OF THE INVENTION

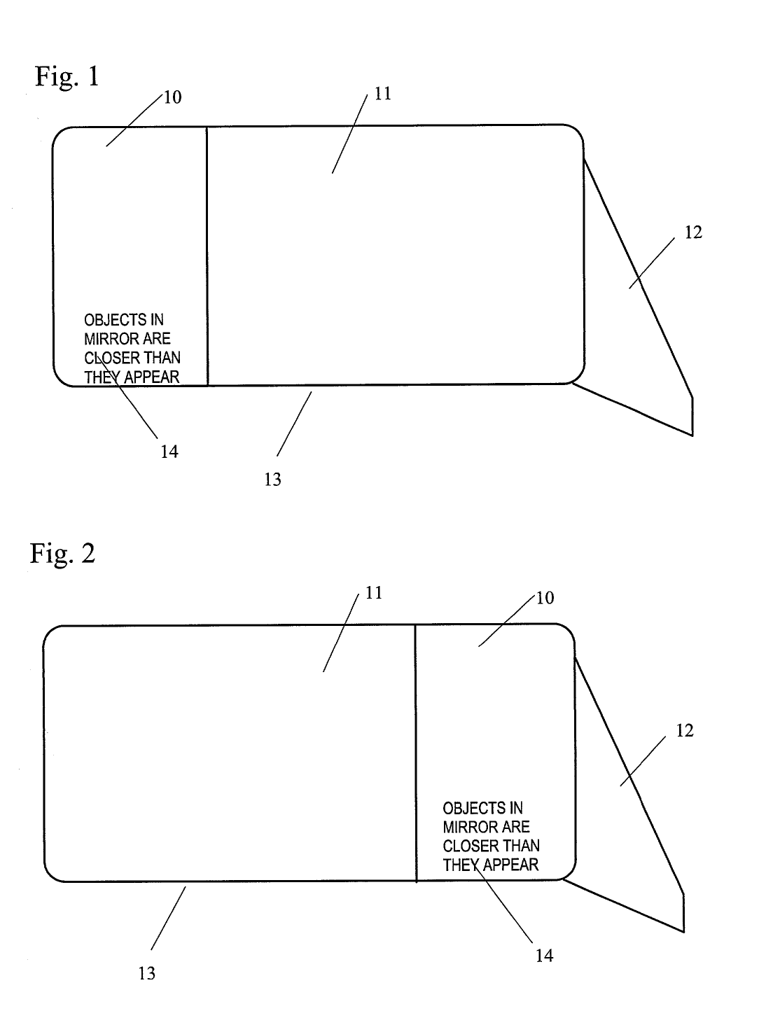

FIGS. 1 through 4 show views of different arrangements of the mirror of the invention. In all of the arrangements, the side-view mirror (13) (preferably mounted on a swivel or other movable mounting in a conventional aerodynamic housing (not shown)) is attached to the car via a strut (12) attaching to the door or fender of the car. It will be understood that while the mirrors shown in the figures show the strut at the right (i.e. they are left-hand or driver-side mirrors), the invention would be equally applicable to right-hand side-view mirrors.

The mirror of the invention has a unitary body—that is, a single mirror rather than separate mirrors or added-on partial mirrors—having a convex mirror portion (10) which makes up approximately one third of the entire mirror (13), and a flat portion (11) making up the remaining two thirds of the mirror. In FIG. 1, the convex portion (10) is located at the end of the mirror that is furthest away from the strut mounting the mirror to the car door (12). At the bottom of the convex portion (10) of the mirror there is the statement (14) required on convex side-view mirrors by Federal Motor Vehicle Safety Standard #111, paragraph S5.4.2 (49 CFR 571.111), that “OBJECTS IN MIRROR ARE CLOSER THAN THEY APPEAR”. In FIG. 2, the convex portion (10) is located closest to the door (12).

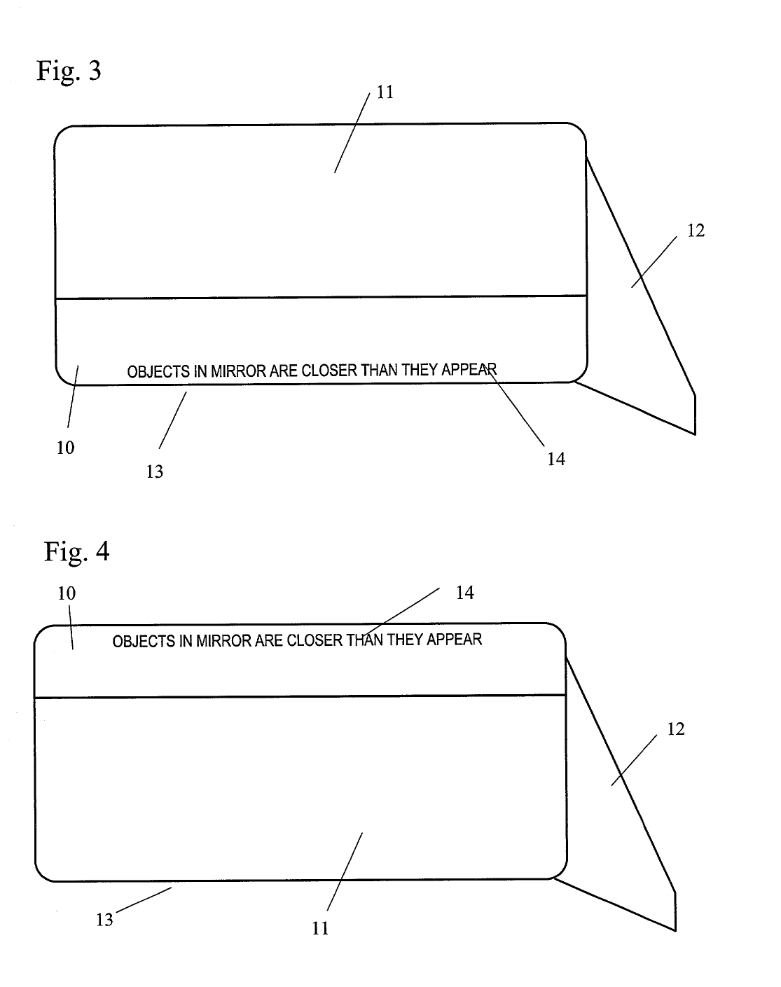

FIGS. 3 and 4 show a variation where the convex portion (10) of the mirror (13) is vertically arranged below (FIG. 3) or above (FIG. 4) the flat (11) portion. Again, as in the side-by-side arrangement of FIGS. 1 and 2, the convex portion (10) consists of approximately one third of the total amount of mirror present. At the bottom of the convex portion (10) of the mirror (13), as noted above, there is the required statement regarding objects being closer than they appear (14).

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A side-view mirror for motor vehicles having a unitary body comprising a convex portion and a flat portion.

2. The side-view mirror of claim 1, wherein the convex portion comprises approximately one third of a total extent of the unitary mirror.

3. The side-view mirror of claim 1, wherein the convex portion comprises approximately one third of a total extent of the unitary mirror.

4. The side-view mirror of claim 1, in which the body is divided horizontally into the convex portion and the flat portion.

5. The side-view mirror of claim 1, in which the body is divided vertically into the convex portion and the flat portion.

6. The side-view mirror of claim 1, further comprising an aerodynamic housing to which the mirror is movably mounted.

7. The side-view mirror of claim 1, further comprising a strut for mounting the mirror to a vehicle.
